(19) United States
(12) Patent Application Publication
(10) Pub. No.: US 2006/0140056 A1
(43) Pub. Date: Jun. 29, 2006

(54) Timepiece with multiple location time indicator

(76) Inventor: Ronald S. Lizzi, Bethany, CT (US)

Correspondence Address: Arthur G. Schaier;Carmody & Torrance LLP, P.O. Box 1110, 50 Leavenworth Street, Waterbury, CT, 06721-1110, US

(21) Appl. No.: 11/025,208

(22) Filed: Dec. 29, 2004

(51) Int. Cl. G04B 19/22

(52) U.S. Cl. 368/21

(57) ABSTRACT

In a timekeeping device, a method for displaying a time in each of a plurality of locations, wherein the timekeeping device has stored therein for each of the plurality of locations a respective seasonal offset relative to a standard time, wherein the timekeeping device comprises (i) a display indicator for indicating a location selected from the plurality of locations and (ii) seasonal adjustment means for adjusting the time in the selected location by the seasonal offset; wherein the method comprises the steps of selecting a location from the plurality of locations; actuating a seasonal adjuster to account for a change of seasons; and displaying the time, adjusted for the seasonal offset. A timekeeping device that comprises a display for displaying time information; a display indicator for indicating a location selected from the plurality of locations; adjustment means for adjusting the time in the selected location by the time offset; actuation means for actuating the adjustment means; and a time indicator for displaying on the display, a time in the location, which reflects the time offset, is also provided.

### BACKGROUND OF THF INVENTION

The present invention is directed generally to multimode electronic devices, such as wristwatches (but not by limitation), and, in particular, to a novel timepiece construction (with display) and methodology for displaying time information across and/or within multiple time zones, and in particular, across multiple cities around the world.

Many patents have been sought to protect ways to manage and keep track of appointments, schedules and the like across different time zones. For example, when a person travels, he or she must maintain (or adjust) his or her timekeeping device for multiple time zones. Similarly, when scheduling a meeting, appointment, conference or the like with participants in different time zones (e.g. cities/locations), one is required to constantly remain mindful of the possible and/or particular time zone differences.

Complicating the issue even further is the observance, in many places around the world, of “Daylight Saving Time” (or “Summer Time” as it is called in many countries). Daylight Savings Time or “DST” is a way of getting more out of the summer days by advancing the clocks (e.g. by one hour) during the summer. Then, the sun will appear to rise one hour later in the morning when people are usually asleep anyway, at the benefit of one hour longer evenings when awake. DST is considered a useful factor in saving energy and increasing the pleasing effect of “lighter” evenings.

To make DST work, one's timekeeping device (e.g. a watch and/or clock) has to be adjusted (e.g. one hour) ahead when DST begins (during spring), and adjusted back (e.g. one hour) to Standard Time every autumn. There are many countries observing DST, and many who do not. Generally speaking, during the months April/May-October/November, the countries on the northern hemisphere are having their summer and may observe DST, while the countries in the southern hemisphere are having winter, and not observant of DST. During the rest of the year (October/November-April/May) it is the opposite, namely, winter on the northern hemisphere, summer in the southern.

Generally speaking, DST is almost always 1 hour ahead of normal time, but during history there has been several variants of this, such as half adjustments (30 minutes) or double adjustments (2 hours), but adjustments of 20, 40 minutes have also been used. Other exceptions also exist.

It would be advantageous to display the “local” time in various places both here in the U.S. and abroad and be able to readily display such “local” times taking into account the applicability (i.e. affect) of DST. It is believed that the prior art is devoid of a desirable way to provide the foregoing easily and conveniently and in connection with wristwatches, and in particular, with an analog timepiece.

For example, FIGS. 1A, 1B, 1C and 1D illustrate how DST affects the time (note that in Tokyo, DST has no affect) in four cities, randomly selected for illustrative purposes. The times are shown in two states, standard time and daylight savings time. FIG. 2 accumulates the information of FIGS. 1A-1D into one graph of the two seasons. From FIG. 2, it can be seen that all of the foregoing cities have either one or two states for its time. The transitions from DST to standard time (and visa versa) may be at different times (e.g. months) of the year, but they are within relatively narrow bands of time, i.e. roughly within one month. Compounding the issue of user confusion is the fact that users are often unaware of DST, whether a particular city (or location) is currently observing DST or whether the city (or other location) observes DST in the first instance.

There are at least several prior art references that describe “global time indicators” and/or recognizes the need to account for shifts in the “local” time, such as by Standard Time and Daylight Savings Time offsets, such as U.S. Pat. Nos. 6,788,622; 6,647,370; 6,597,635; 6,330,970 and 4,847,819 and published U.S. application Serial No. 2002/0122355. Moreover, Casio currently markets a watch that has an adjustment to account for daylight savings time.

However, as best understood, the prior art is devoid of a sufficiently easy, convenient and user-friendly method or construction of taking into account DST, if applicable, and displaying the adjusted time on a display. In a particularly glaring deficiency, the known prior art appear to lack a description of a satisfactory device or methodology for displaying such adjusted time information easily and conveniently on an analog timepiece.

Accordingly, it has been recognized that improvements in the ability to display time information in various locations, which takes into account any needed adjustment for DST, are desirable. Specifically, what is needed is a timekeeping device and methodology that allows users to easily take into account DST regardless of whether the user knows anything about DST, knows whether the location (for which the user wants to know the time) is in DST (or not), knows which cities observe DST or when the transition from DST to standard time (and back) occurs. In one particular embodiment for example, what is needed is a timekeeping device and method for being able to easily and conveniently adjust for DST and obtain time information in each of a plurality of locations using display hands for displaying the time information.

### SUMMARY AND OBJECTIVES OF THE INVENTION

It is thus an objective of the present invention to overcome the perceived deficiencies in the prior art.

For example, it is an objective of the present invention to provide a timekeeping device and method for displaying a local time in the U.S. and/or around the world, taking into account offsets, such as those attributable to the recognition and application of Daylight Savings Time.

It is yet another objective of the present invention to provide a timekeeping device and method that allows users to easily take into account DST regardless of whether the user knows anything about DST, knows whether the location (for which the user wants to know the time) is in DST (or not), knows which cities observe DST or when the transition from DST to standard time (and back) occurs.

It is another objective of the present invention to provide such a timekeeping device and method that is more convenient and user-friendly, thus providing a user with a more convenient and user-friendly way of displaying local times in the U.S. and/or around the world, taking into account offsets, such as the aforementioned application of Daylight Savings Time.

It is yet another objective of the present invention to provide a timekeeping device and method that allows for the more accurate planning and/or maintaining of appointments, meetings, travel plans when involving more than one time zone, especially taking into account DST.

It is yet a further objective of the present invention to provide the foregoing features on a wristwatch using display hands.

Further objects and advantages of this invention will become more apparent from a consideration of the drawings and ensuing description.

The invention accordingly comprises the features of construction, combination of elements, arrangement of parts and sequence of steps which will be exemplified in the construction, illustration and description hereinafter set forth, and the scope of the invention will be indicated in the claims.

Generally speaking, the present invention is directed to a timekeeping device and methodology that essentially “normalizes” the times in all of the selectable cities. As indicated above, the present invention recognizes the fact that any city has either one or two states for their time. Although the transitions may be at different times of the year, they are within relatively narrow bands of time (i.e. a month). The present invention provides a user with quick and accurate potential “range” of times (assuming that the city adjusts for DST in the first instance) for that particular city at any particular time. In fact, if it is February or July, for example the present invention's season setting always provides for the display of the correct “local” time for each city. On the other hand, any uncertainty in the date of the transition between Standard Time and DST (or back) for a city of interest is minimized by the ability to toggle the season setting and see the “range” of possible times.

To overcome the perceived deficiencies in the prior art and to achieve the objects and advantages set forth above and below, the present invention is, generally speaking, directed to a method for displaying a time in each of a plurality of locations, wherein the timekeeping device has stored therein for each of the plurality of locations a respective seasonal offset relative to a standard time, wherein the timekeeping device comprises (i) a display indicator for indicating a location selected from the plurality of locations and (ii) seasonal adjustment means for adjusting the time in the selected location by the seasonal offset; wherein the method comprises the steps of selecting a location from the plurality of locations; actuating a seasonal adjuster to transition between a change of seasons; and displaying the time, adjusted for the seasonal offset.

Also provided is a timekeeping device for displaying a time in each of a plurality of locations, wherein the timekeeping device has stored therein for each of the plurality of locations a respective time offset relative to a standard time, wherein the timekeeping device comprises a display for displaying time information; a display indicator for indicating a location selected from the plurality of locations; adjustment means for adjusting the time in the selected location by the time offset; actuation means for actuating the adjustment means; and a time indicator for displaying on the display, a time in the location, which reflects the time offset.

In a specific embodiment, the timekeeping device disclosed herein is preferably a wristwatch.

### BRIEF DESCRIPTION OF THE DRAWINGS

For a fuller understanding of the invention, reference is had to the following description taken in connection with the accompanying figures, in which:

FIGS. 1A, 1B, 1C and 1D illustrate how DST affects the time in four cities, randomly selected for illustrative purposes;

FIG. 2 illustrates the cumulative information of the differing times for the four cities illustrated in FIGS. 1A-1D.

FIG. 3 is a top plan view of a timekeeping device constructed in accordance with the present invention, particularly illustrating much of the display indicia and display indicators that makes the present invention unique;

FIGS. 4-6 are top plan views of the timekeeping device of FIG. 3 with some of the display indicia removed for ease of disclosing the present invention; and

FIG. 7 is a chart illustrating a plurality of illustrative cities and their respective time zones, along with their respective specified seasonal offsets from Greenwich Mean Time.

Identical reference numerals in the figures are intended to indicate like features, although not every feature in every figure may be called out with a reference numeral.

### DETAILED DESCRIPTION OF THE PREFERRED EMBODIMENTS

Generally speaking, the present invention provides for the ability to display, with the use of one or more indicator (e.g. display) hands, the “local” time in each of a plurality of locations (e.g. cities) both here in the United States and abroad, while also taking into account, if applicable, an offset such as DST. More particularly, is the idea that the present invention provides users valuable time information regardless of whether the user knows anything about DST, such as regardless of whether the user knows if the “local” time the user seeks is in DST or not, whether the city observes DST in the first instance and/or what month of the year the transition, from DST to Standard Time (and/or back), occurs.

Generally, two types of times are important to a user, namely the user's “home” time and one or more “local” times (e.g. “elsewhere”). For purposes of avoiding ambiguity, “home” time as referred to herein is intended to mean the time in the time zone where the user typically spends most of his or her time, e.g. the user's residence. “Local” time as referred to herein shall have two meanings, namely, that the “local” time can be thought of as (i) the time in the locale where the user is physically located at any particular instant in time or (ii) the time in a locale remotely located from the user at any instant in time (i.e. the user need not be physically located there at the moment). As an example of the foregoing terminology, a person residing in Connecticut (but physically standing in California) may consider the “time of day” in Connecticut at his/her “home” time, but the “time of day” in California as the “local” time. Similarly, while physically standing in Connecticut or California, the user would be able to check his watch to see the “local” time in London. While others may refer to this latter time as a “remote” time, use of the term “local” will suffice in connection with the present invention.

The present invention is directed to a device and method of displaying both the home time and one or more local times, adjusted for daylight savings time as necessary, in a timekeeping device. In the preferred embodiment, the timekeeping device is a wristwatch.

The present invention takes advantage of the expanded timekeeping display capabilities provided by the invention disclosed in co-owned and co-pending application Ser. No. 10/441,417, the disclosure of which is incorporated by reference as if fully set forth herein. Specifically, the invention disclosed in the '417 application provides one skilled in the art with sufficient details to construct a timepiece having the plurality of indicator hands preferably utilized in the invention disclosed herein. For example, the '417 application describes the preferred inner workings of a timepiece, comprising the basic construction and arrangements of gears and/or gear trains to rotate a plurality of “standard” hands all supported on a center stem, such as an hour hand 18, a minute hand 20 and a “seconds” hand 22. Thus, such a description will be omitted as being well within the purview of one skilled in the art. Furthermore, the '417 application discloses the position, construction, use and operation of “other” display hands (i.e. herein referred to with numerals 24, 26, 28), aside from the conventional hour, minute and “seconds” hands. As the disclosure of this '417 application is likewise incorporated by reference herein for this disclosure, specific details may be omitted for purposes of brevity. However, as the use of display hands 24, 26 and 28 are specific to the present invention, disclosure will be made.

As illustrated in the figures, timekeeping device 10 includes a bezel, ring, dial or the like with a plurality of cities indicated therearound. As will become clearer below, any of the cities on this “display” may be selected by the pointing thereto by indicator hand 24.

Similarly, each indicator hand 26, 28 have associated therewith its own display, indicated respectively by reference number 30, 32. The scale (i.e. with respect to display 30) and/or other information (i.e. with respect to the “summer”/“winter” indicators on display 32) are preferably printed, silk-screened or otherwise provided on dial 36, and the demarcations of such scales are one of design choice and a function of the parameter(s) being measured or otherwise displayed, as discussed in greater detail below. Importantly, with respect to display 32, it should be understood that the use of “winter” and “summer” icons are only intended to be used as a shorthand for the part of the year from between about September/October-March/April on the one hand, and March/April-September/October on the other.

Thus, in the preferred embodiment, timekeeping device 10 will comprise four stepper motors, and one skilled in the art would recognize that varying the number of displays and display hands can vary the number of needed stepper motors, all of which is within the scope of the present invention and disclosure. With the purpose of display hands 24, 26 and 28 being more fully disclosed below, it will be sufficient to disclose that one of the stepper motors is provided to rotate (via a gear train) hour hand 18, minute hand 20 and “seconds” hand 22; hand 24 is rotated (via a gear train) by a second stepper motor; while hands 26, 28 are each respectively rotated (via respective gear trains) by a third and fourth stepper motor. The construction of the respective gear trains is well within the purview of one ordinarily skilled in the art.

Preferably, the stepper motors associated with hands 24, 26 and 28 are bi-directional stepper motors thus being able to rotate in either direction, with as many as two rotor steps per revolution (or 180° per rotor step), and the construction of acceptable stepper motors to functionally operate in this manner are widely commercially available and well within the understanding of those skilled in the art.

In the instant invention, pushers are the preferred means to manually cause the stepping of the stepping motors operatively coupled to display hands 24, 26 and 28. Specifically, for any given operation, actuation of pusher PB2 will preferably rotate the selected display hand counterclockwise, while actuation of pusher PB4 will preferably rotate the selected display hand clockwise. Pusher PB8 is preferably dedicated to toggling the position of display hand 28, as will become clearer below. Reference should also be made to the '417 application for among other things, details of circuit diagrams, the operative coupling of switches which are intended to generically indicate both side/top mounted pushers such as push buttons PB2, PB4 and PB8, and of controller 100, which contains all the functionality needed by the controller of the present invention and thus incorporated by reference herein for that purpose.

As will also become clear below, it is important to also be able to calibrate the positioning of display hands 24, 26 and 28. In this way, the controller (e.g. controller 100 of the '417 application) can maintain “knowledge” of the positioning of display hands 24, 26 and 28. For at least this reason, the disclosure of application Ser. No. 10/737,406, entitled “Method And Construction For Autocalibrating An Actuation Mechanism In An Electronic Device,” is incorporated by reference as if fully set forth herein.

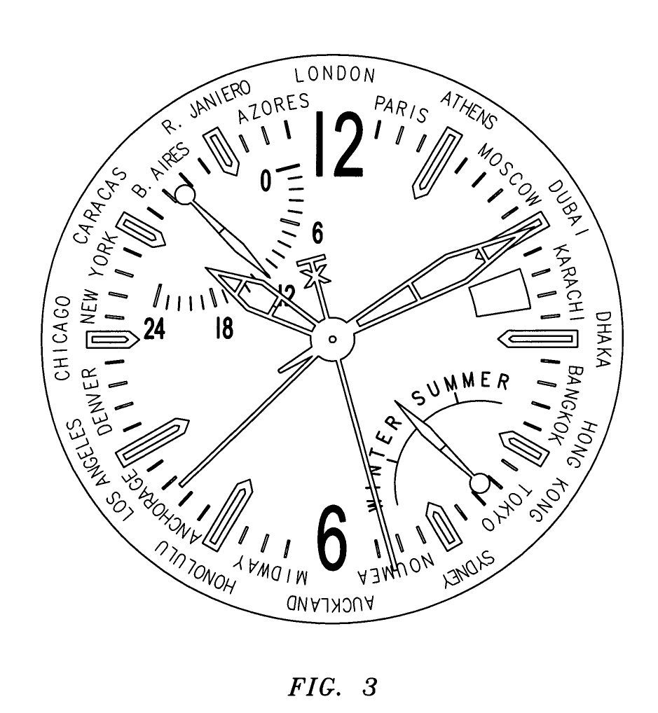

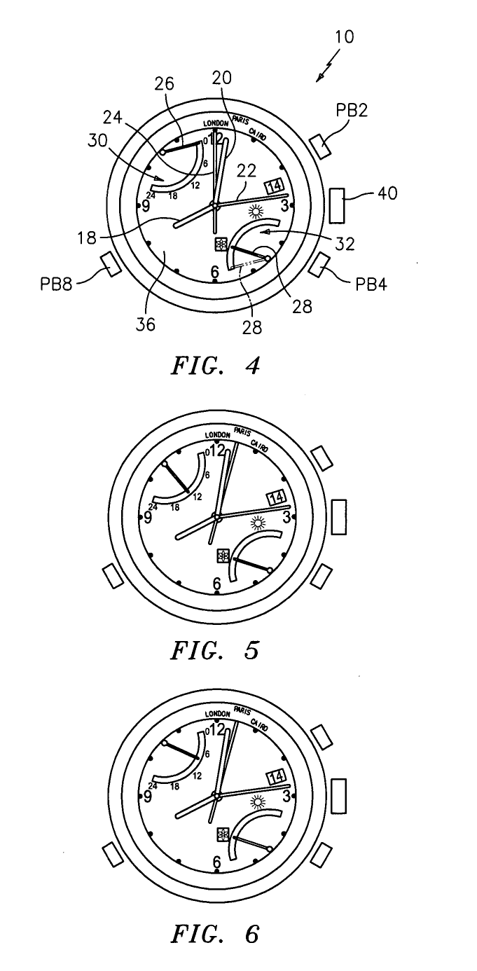

With the foregoing now disclosed by way of background, reference is now made to the figures for a more detailed disclosure of the present invention, with reference being particularly made to FIGS. 4-6, although it being understood that a fuller illustration of the preferred display of device 10 can be found in FIG. 3.

FIG. 4 illustrates timekeeping device 10 undergoing a calibration sequence. Specifically, although it can be assumed that local time-setting and/or a local/home time zone can be set at the time of manufacture, a change of batteries, for example, can essentially clear stored information. Therefore, it is important that a preferred series of steps be provided to calibrate display hands 24, 26, 28. In this way, the controller will “know” where the hands are positioned, thus leading to accurate timekeeping and display functionality.

The preferred methodology of hand calibration comprises the initial step of pulling crown 40 outwardly to a selected “set” position, which in the preferred embodiment is the second axial position (although it is within the purview of the skilled artisan to initiate hand calibration when the crown (i.e. setting stem) is in a different axial position.

Upon the axial displacement of crown 40 to the second “set” position, “second” hand 22 will operationally disengage from its associated stepper motor. Here, and under the control of the controller, display hands 26 and 28 will then rotate to an initialized position (e.g. display hand 26 rotates to the “0” position on display 30 and display hand 28 rotates from an extreme initialized position to a position so as to point to one of the seasonal indicators (i.e. “winter”)), in a manner set forth in application Ser. No. 10/737,406. Additionally, center hand 24 will rotate to its home position, which is preprogrammed to be the “12:00” (i.e. vertical) position. It should be noted that because hands 26 and 28 can only move within a limited arc (e.g. sweep), calibration thereof by the use of, among other things, respective mechanical stops, is relatively straightforward as disclosed in the '406 application. With the stem preferably in the second axial position, the preferred method provides for the toggling of display hand 28 to indicate the current “season” of year. Such toggling is preferably done by actuation of a pusher, e.g. pusher P8 (the “seasonal adjuster”).

It should be apparent to the skilled artisan that center hand 24 may not be as easily calibrated due to its ability to rotate 360°. Therefore, manual calibration to its “home” (e.g. “vertical”) position may be necessary, an operation carried out in the preferred embodiment by selected actuation of pushers PB2 and/or PB4 so as to manually step center hand 24 counterclockwise or clockwise, respectively, until it is in its home (“12:00”) position.

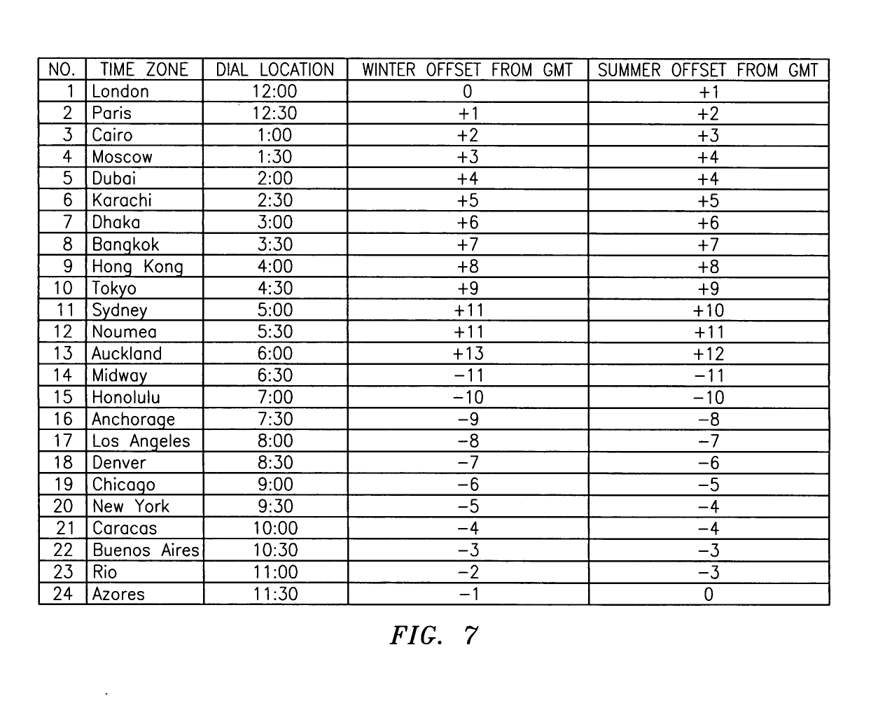

At this point, the position of hands 24, 26, 28 have been calibrated, and home time zone setting can be performed, and reference is thus made to FIGS. 5 and 6.

For time setting and time zone setting, the preferred embodiment provides for crown 40 to be displaced to its first “set” position, which is intermediate the “normal” run position and the aforementioned second “set” position. Here then, center hand 24 will rotate to its factory set “home time zone,” which in the preferred embodiment defaults to the position indicated by “Paris,” although it should be clear that this is by example and not limitation. Similarly, display hand 26, which has been previously calibrated, can now move to its defaulted home time (e.g. rotating to indicate the 12:00 hour). At this point in the preferred setting operation, a new home time zone can be selected by rotation of the center hand to a position (caused by the selected actuation of pushers PB2 (counterclockwise) and/or PB4 (clockwise)) indicating the desired home time zone.

With the home time zone now set, it is preferable to set the correct hour (i.e. “home time”) to be displayed by display hand 26. Once again, the preferred embodiment prefers for the axial displacement of crown 40 to the second “set” position. Since this is again the calibration mode, timekeeping device 10 provides for timesetting if no pusher actuation occurs within a predetermined period of time (e.g. 5 seconds). Here, the current minutes of the home time zone can be indicated by rotating center hand 24 to the accurate indicator of minutes (again, performed by actuation of pushers PB2 or PB4). It is important to keep in mind that the controller is maintaining information regarding the position of center hand 24. In this way, the controller can also cause the appropriate amount of rotation of display hand 24 (e.g. for a rotation amounting to a span of 12 minutes by display hand 24, display hand 26 will rotate one unit representing a 12 minute increment). Therefore, if it is desired to rotate display hand 26 to a subsequent hour position, center hand 24 must be rotated 360°, in a manner similar to rotating the minute hand to rotate the hour hand of a conventional analog watch.

Furthermore, when crown 40 is in this second “set” position, the conventional (e.g. local) time (i.e. with hour hand 18 and minute hand 20) can be set, all in accordance with conventional setting steps (e.g. rotating the crown/stem).

With the home time zone set, the time in the home time zone set (i.e. with display hand 26) and the conventional hour hand 18 and minute hand 20 set, timekeeping device is fully and accurately operational to display the time in any number of a plurality of locations, and more specific to the present invention, able to more easily, quickly and efficiently account for and provide for the display of any applicable time offset (e.g. from the Standard Time) using the display hands.

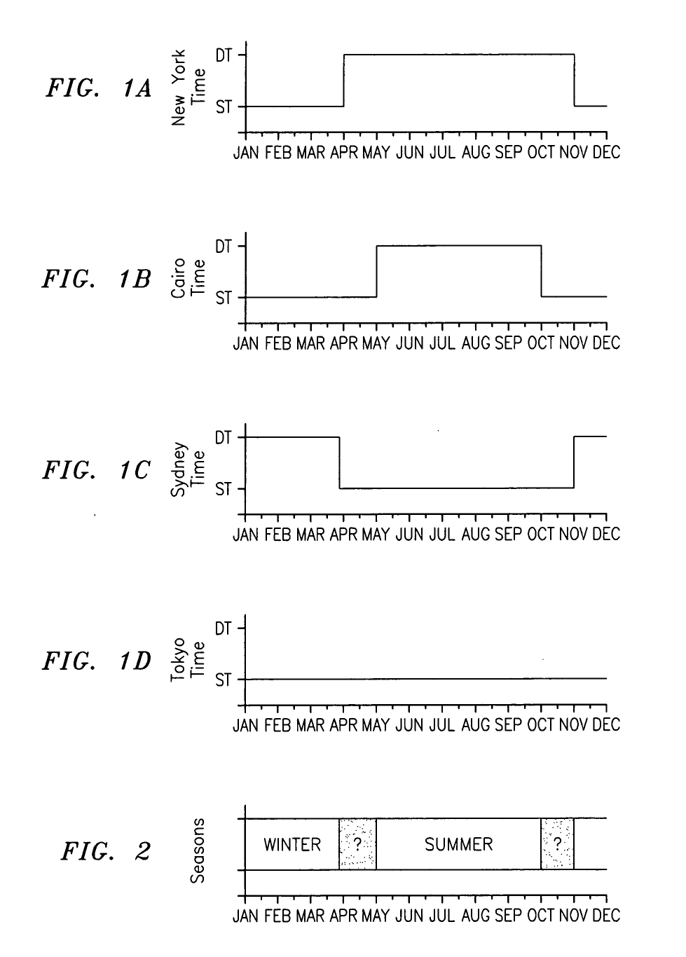

For example, and generally speaking, the present invention provides for the displaying of a time in each of a plurality of locations, and therefore, comprises the steps of selecting a location from the plurality of locations. This step is preferably carried out by pressing either pusher(s) PB2 and/or PB4 to rotate center hand 24 in one of a (respective) counterclockwise or clockwise direction. With each city/location to which center hand 24 points, display hand 26 will correspondingly rotate to indicate the hour in the city/location being pointed to by center hand 24 (it should be appreciated that minute hand 20 need not move because presumably minute hand 20 is already accurately set to the proper minutes). In accordance with the present invention, the time displayed on display 30 will be the local time in the city/location indicated by center hand 24. If the current “season” of year is not accurately being indicated by display hand 28 (or the current month is within or very close to the transitional periods noted in FIG. 2), display hand 28 can then be adjusted (toggled) if necessary. However, as illustrated in FIG. 2, most of the year, the season is the same for all cities. Thus, the user may select any city and the correct time will be displayed without the need for any adjustment to the season by the user, unlike the prior art.

Using the theory presented in FIGS. 1 and 2, one skilled in the art can create a table for a plurality of time zones and cities, an exemplary one of which is set forth in FIG. 7. From this table, one skilled in the art can translate this information for memory storage in and later recall from the device of the present invention. Thus, with the memory of timekeeping device maintaining time information relative to each of the available cities for selecting, as well as the respective offsets relative to Greenwich Mean Time (or Standard Time) and the “season” in which such offset is applicable, it can be seen that use of center hand 24 to indicate the desired city in combination with use of display hand 28 to adjust, as necessary, for the seasonal offset, a more convenient, user friendly and easy to use timekeeping device and methodology is provided for displaying accurate home and local time in a plurality of locations using display hands.

It should thus be clear that the ordering of steps in the claims is not material to the present invention. For example, the present invention also contemplates a methodology comprising the steps of actuating a seasonal adjuster (e.g. PB8) to account for a change of seasons; selecting a location (e.g. with center hand 24) from the plurality of locations; and displaying the time (with at least display hand 26), adjusted for the seasonal offset. However, in practice, the method appears to lend itself to a user actuating the seasonal adjuster (e.g. pusher PB8) so that the displayed time may, if applicable (i.e. compare FIGS. 1A, 1B, 1C with that of FIG. 1D) toggles between (i) the standard time in the selected location and (ii) the time, adjusted by the seasonal offset, in the selected location after the location has been selected. With the step of selecting a location (e.g. by rotating center hand 24) until it points to a desired location indicated on the timekeeping device, the step of adjusting the season is carried out by actuation of the pusher (e.g. PB8) operatively coupled to the seasonal adjustment means, which itself may comprise such elements as the stepping motor associated with hand 26 and/or the controller. Again, toggling of hand 28 (e.g. by actuation of pusher PB8) causes the adjusting of the season, and hence, will (if applicable) adjust the time to account for the removal (if applicable) of the seasonal offset.

It should thus be kept in mind that a timekeeping device to carry out the foregoing methodology is likewise provided, and in the preferred embodiment comprises a display for displaying time information; a display indicator (e.g. hand 24) for indicating a location selected from the plurality of locations; adjustment means (e.g. the stepping motor, controller, and/or selected memory) for adjusting the time in the selected location by the time offset; actuation means (pusher PB8) for actuating the adjustment means; and a time indicator (e.g. hand 26 and may include hand 20) for displaying on the display, a time in the location, which reflects the time offset.

Lastly, it should be kept in mind that the present invention is applicable to a digital watch wherein information is displayed digitally (i.e. a LCD or LED display). Such an embodiment would thus comprise a display for displaying time information; a display indicator (which can also be provided digitally) for indicating a location selected from the plurality of locations; adjustment means (e.g. a microcontroller and/or selected memory) for adjusting the time in the selected location by the time offset; actuation means (e.g. a pusher) for actuating the adjustment means; and a time indicator (e.g. time indicia) for displaying on the display, a time in the location, which reflects the time offset.

While the invention has been particularly shown and described with respect to preferred embodiments thereof, it will be understood by those skilled in the art that changes in form and details may be made therein without departing from the scope and spirit of the invention.

It can thus be seen that the present invention provides for significant advancements over the prior art, including providing constructions for setting and indicating the time (using display hands) in a plurality of locations, and adjusted if necessary for DST. In particular, the present invention provides a timekeeping device and method that allows users to easily take into account DST regardless of whether the user knows anything about DST, knows whether the location (for which the user wants to know the time) is in DST (or not), knows which cities observe DST or when the transition from DST to standard time (and back) occurs.

Moreover, the use of display hands in one of the particularly disclosed embodiments for carrying out the foregoing methodology provides for a unique and more convenient and user-friendly approach than found in the prior art.

What is claimed is:

1. On a timekeeping device, a method for displaying a time in each of a plurality of locations, wherein the timekeeping device has stored therein for each of the plurality of locations a respective seasonal offset relative to a standard time, wherein the timekeeping device comprises (i) a display indicator for indicating a location selected from the plurality of locations and (ii) seasonal adjustment means for adjusting the time in the selected location by the seasonal offset; wherein the method comprises the steps of:
selecting a location from the plurality of locations;
actuating a seasonal adjuster to account for a change of seasons; and
displaying the time, adjusted for the seasonal offset.

2. The method as claimed in claim 1, wherein the displaying of the time comprises the step of actuating the seasonal adjuster; and
wherein the displayed time changes between (i) the standard time in the selected location and (ii) the time, adjusted by the seasonal offset, in the selected location.

3. The method as claimed in claim 2, wherein:
the step of selecting a location includes the step of indicating a location indicated on the timekeeping device; and
the step of adjusting the time is carried out by actuation of a pusher operatively coupled to the seasonal adjustment means.

4. The method as claimed in claim 3, wherein the step of indicating a location indicated on the timekeeping device includes the step of rotating at least one display hand until the display hand indicates the location.

5. The method as claimed in claim 4, wherein the step of displaying the time is carried out by the use of at least one display hand.

6. The method as claimed in claim 1, including the step of adjusting the time to account for the removal of the seasonal offset, wherein the step of adjusting the time comprises the step of actuation of a pusher.

7. On a timekeeping device, a method for displaying a time in each of a plurality of locations, wherein the timekeeping device has stored therein for each of the plurality of locations a respective seasonal offset relative to a standard time, wherein the timekeeping device comprises (i) a display indicator for indicating a location selected from the plurality of locations and (ii) seasonal adjustment means for adjusting the time in the selected location by the seasonal offset; wherein the method comprises the steps of:
actuating a season selector for selecting a season selected from at least two seasons;
selecting a location from the plurality of locations;
displaying a time in the location, which reflects a seasonal offset; and
adjusting the season selector to select another of the selectable seasons and adjusting the displayed time in the location to account for removal of the seasonal offset.

8. The method as claimed in claim 7, including the step of toggling the displayed time between (i) the standard time in the selected location and (ii) the time, adjusted by the seasonal offset, in the selected location.

9. The method as claimed in claim 8, wherein:
the step of selecting a location includes the step of indicating a location indicated on the timekeeping device; and
the step of adjusting the time is carried out by actuation of a pusher operatively coupled to the seasonal adjustment means.

10. The method as claimed in claim 9, wherein the step of indicating a location indicated on the timekeeping device includes the step of rotating at least one display hand until the display hand indicates the location.

11. The method as claimed in claim 10, wherein the step of displaying the time is carried out by the use of at least one display hand.

12. A timekeeping device for displaying a time in each of a plurality of locations, wherein the timekeeping device has stored therein for each of the plurality of locations a respective time offset relative to a standard time, wherein the timekeeping device comprises:
a display for displaying time information;
a display indicator for indicating a location selected from the plurality of locations;
adjustment means for adjusting the time in the selected location by the time offset;
actuation means for actuating the adjustment means; and
a time indicator for displaying on the display, a time in the location, which reflects the time offset.

13. The timekeeping device as claimed in claim 12, wherein the adjustment means causes the time indicator to toggle the displayed time information between (i) the standard time in the selected location and (ii) the time, adjusted by the seasonal offset, in the selected location.

14. The timekeeping device as claimed in claim 12, wherein:
the adjustment means comprises at least a stepping motor and a controller; and
the actuation means comprises a pusher operatively coupled to the adjustment means.

15. The timekeeping device as claimed in claim 14, wherein the time indicator is a display hand operatively coupled to the adjustment means.
